(19) United States
(12) Patent Application Publication
(10) Pub. No.: US 2009/0103720 A1
(43) Pub. Date: Apr. 23, 2009

(54) Method and system for secure and anti jamming wireless communication with high spectral efficiency

(76) Inventor: Manoj Karayil Thekkoott Narayanan, Kerala (IN)

Correspondence Address: ALIX YALE & RISTAS LLP, 750 MAIN STREET, SUITE 1400, HARTFORD, CT, 06103, US

(21) Appl. No.: 11/793,457

(22) PCT Filed: Jun. 7, 2005
(86) PCT No.: PCT/IN2005/000194

§ 371 Date: Jun. 20, 2007

(51) Int. Cl. H04L 9/20

(52) U.S. Cl. 380/34

(57) ABSTRACT

Invention presented here relates to Low Probability of Exploitation and Anti Jamming communication system offering high spectral efficiency. The object of the present invention is achieved by hopping in polarization domain and by employing an adaptive polarization-nulling algorithm (FIG. 18, H [2,2]) to detect and eliminate jamming signal. The use of signals which hops or spreads in polarization domain does not need wide frequency spectrum due to which, the said modulation when employed at the physical layer offers and extremely secure and survivable wireless communication at very high data rates.

### FIELD OF THE INVENTION

Present invention relates to a Low Probability of Exploitation and Anti Jamming communication system offering high spectral efficiency.

### BACKGROUND OF THE INVENTION

### Description of the Prior Art

Cryptography, the art and science of keeping messages secure are widely practiced in secure communication systems and networks. Most of the cryptographic operations are conventionally performed at the higher layers of the network and may be implemented by software or hardware or a combination of both. When cryptographic techniques are implemented at the physical layer, the cryptanalysis needs to adopt a sequential approach of firstly, to identify and characterize the signal and secondly to decipher the information (plain text). The job of identifying and characterizing the signal is performed by intercept receivers. Deciphering the signal is processed by the intercept receiver which is similar to the cryptanalysis performed at higher layers of the network.

Low Probability of Exploitation (LPE) and Anti Jamming (AJ) are the two important features of any secure and survivable communication system. The stealth property of a communication system is ensured by employing a modulation which offers LPE which encompasses both Low Probability of Detection (LPD) and Low Probability of Interception (LPI). The availability of a communication link in hostile conditions is ensured by employing a modulation which possesses Anti Jamming property.

Presently, LPE and AJ communication systems are designed based on modulations which employ spreading or hopping in time, frequency or phase domains and are inherently wideband. Both Direct Sequence Spread Spectrum (DSSS) and Frequency Hopping Spread Spectrum (FHSS) offer LPE and AJ properties at the cost of bandwidth (spectrum) redundancy. With the advent of high speed signal processors and signal processing algorithms offering high computational efficiency, the existing methods are becoming increasingly vulnerable to signal intelligence and intended interference or jamming. Moreover, with the electromagnetic spectrum getting ever more congested, wide band (wide spectrum) LPE and AJ solutions need to be replaced with narrowband techniques for conserving spectrum. As the data rate of communication links grows exponentially, the wideband modulations such as DSSS, FHSS become less attractive choices due to the high cost involved in the spectrum occupation. For example, a data link of 10 Mbps transmission rate will occupy a spectrum of more than 500 MHz width to offer an acceptable AJ feature if DSSS or FHSS are used. This shows that the DSSS and FHSS are not suitable for high data rate wireless communication networks. The prior art modulation system requires bandwidth redundancy to provide LPE and AJ features to a wireless communication link and hopping in frequency or phase domains needs wide spectral requirement. What is needed is a modulation which is narrowband in nature, yet offers excellent LPE and AJ features.

### DISCLOSURE OF THE INVENTION

### Summary of the Invention

Invention presented here is an LPE and AJ communication system offering high spectral efficiency. This object of the present invention is achieved by hopping in polarization domain and by employing an adaptive polarization nulling algorithm to detect and eliminate jamming signal. The use of signals which hops or spreads in polarization domain does not need wide frequency spectrum due to which, the said modulation when employed at the physical layer offers an extremely secure and survivable wireless communication at very high data rates.

A further object of the present invention is to provide a LPE & AJ communication system which is based on Pseudorandom Polarization Shift Keying (PPOLSK) modulation method which can generate polarization hopping using pseudo random assignment of digital information to states of polarization (SOP) of an electromagnetic signal selected from a multitude of constellation arrangements.

The presented modulation in accordance to the invention uses pseudorandom code at the transmitter which maps the digital information onto the SOPs and to generate these SOPs wherein ports of a dual polarization array antenna is fed with suitable amplitude and phase signals.

The system further comprises a suitable amplitude design and phase selection circuits which feed a Right Handed Circular Polarization (RHCP) and a left Handed Circular Polarization (LHCP) antenna, or a Linear Horizontal Polarization (LHP) antenna and a linear vertical polarization (LVP) wherein the State of Polarization (SOP) antenna of the transmitting signal is made to hop pseudo randomly between a set of predetermined SOPs.

At the receiver, the SOP of the incoming electromagnetic wave is determined by sensing the amplitude and phase of the received signals at a high isolation dual polarized array. The amplitude and phase relation ship between the two received signals are further processed in the Stokes space to determine the received state of polarization.

According to the present invention, there is provided a Maximum Likely Cross Polarization Interference Cancellation (ML-XPIC) method which is used along with least square, semi blind or blind channel estimation method to determine the received SOP.

The presence of the jamming signal is identified during the training pilot phase of the operation of the receiver and an estimate of the jamming signal is then cancelled out using Adaptive Polarization Nulling (APN) method. The received symbol is then applied to the inverse hopping method to retrieve the original data which is then sent to the higher layers of the network or the data sink.

According to the present invention, there is always a polarization mismatch when an eavesdropper does not have knowledge of the spreading code wherein the received signal on the fixed polarization antenna assumes noise like properties, thus ensuring a high level of LPE performance.

According to an object the present invention the state of polarization of the transmitted signal changes pseudo-randomly. The signal received on a fixed polarization antenna used by the eavesdropper records an amplitude which changes pseudo randomly within a very high value (when there is a polarization match) and zero (when the polarization of the eavesdropper antenna is orthogonal to the transmitted SOP) wherein conventional receiver cannot demodulate and detect such a noise like received signal thus rendering the system invulnerable to eavesdropping.

It is another object of the present invention wherein the system is spread polarization system where spreading is done in polarization domain. The jamming signal polarization is assumed to be of fixed polarization sense. As the signal between intended parties assume various polarizations for communicating the data, the jamming signal power is greatly reduced by polarization mismatch.

The above object of jamming signal rejection further enhanced by the adaptive polarization nulling method at the receiver. During the training/pilot phase of transmission, a series of coded symbols are inserted into the pilot transmission. During this transmission, the presence of the jamming signal is detected first and then the jamming power and the polarization of the jamming signal are determined. This estimate is then subtracted from the received signal before it is applied to other signal processing sections. A feed back signal is then sent to the transmitter to employ alternate constellation set with the constellation points farthest from the jammer polarization. This jamming signal cancellation is further enhanced by the transmitter which adaptively controls the power of the signals transmitted through the antennas depending on the degree of degradation caused by the jamming power.

It is yet another object of the present invention to alternatively use an adaptive attenuation factor which is employed at the ML-XPIC algorithm which reduces the contribution of the heavily jammed receiving antenna in the decision making.

Still other objects and advantages of the present invention will become readily apparent to those skilled in this art from the detailed description, wherein only preferred embodiments of the invention are shown and described, simply by way of illustration of the best mode contemplated to carry out the invention. As will be realized, the invention is capable of other and different embodiments, and its several details are capable of modifications in various obvious respects, all without departing from the invention.

### BRIEF DESCRIPTION OF THE DRAWINGS

FIG. 1: Poincaré sphere representation of State of Polarization (SOP) of an electromagnetic signal

FIG. 2: Poincaré representation angle pairs (2γ,δ) or (2ε,2τ)

FIG. 3: Stoke's space parameters for representation of SOP

FIG. 4: 4 point constellation with 2 RHEP polarizations and 2LHEP polarizations.

FIG. 5: 8 point constellation with 4 RHEP and 4LHEP

FIG. 6: The BER performance for the 4 point constellation

FIG. 7: BER performance of the 8 point constellation compared to that of 8PSK

FIG. 8: Symbol mapping with multiple levels of randomness at transmitter

FIG. 9: An example of data slicing (grouping) prior to symbol mapping into multiple constellations

FIG. 10: An example of the generation of code 1 and code 2 for the PN symbol assignment

FIG. 11: An example of multiple constellation mapping at the transmitter

FIG. 12: Block schematic of a typical transmitter implementation using DSP, DUC and analog up-conversion

FIG. 13: A Polarization agile antenna array structure employing 2 micro strip patches employed in an embodiment of the invention

FIG. 14: An FPGA, DUC and SSB analog up conversion implementation of the transmitter

FIG. 15: Channel model for the preferred embodiment

FIG. 16: Block schematic of the receiver employing digital down converter and FPGA for receiver base band processing

FIG. 17: receiver block schematic employing zero IF down conversion, ADC and DSP for base band processing

FIG. 18: Receiver Signal processing employing MIMO processing techniques

FIG. 19: Receiver signal processing in Stokes space

FIG. 20: packet format of the data

FIG. 21: Timing synchronization

### DETAILED DESCRIPTION OF THE PREFERRED EMBODIMENT

Modulation identification, interception, and extraction play an important part in both covert and overt operations. Stealth properties of a radio communication system are becoming important performance measures and it is envisaged that in addition to tactical links, even commercial/civilian communication should be equipped with such features to offer information security which is paramount to the economy and well being of the society.

The invention presented here is a narrow band LPE and AJ signaling technique, as an alternative to spread spectrum, which is inherently wideband. Apart from excellent LPE effectiveness, the communication technique of the present provides a high level of Anti jamming capability which is based on PPOLSK modulation, required essentially for the survivability of the communication link in the presence of intended interference.

PPOLSK is a modulation scheme in which SOP of the transmitted signal is employed as the information carrying parameter. Every electromagnetic signal transmitted from an antenna has a polarization which depends on the state of polarization of the antenna. Polarization of an Electromagnetic signal describes the movement of the electric field vector at one point in space as the wave progresses through that point. The tip of the electric field vector can trace a line resulting in linear polarization, a circle resulting in circular polarization or more generally an ellipse, resulting in elliptical polarization.

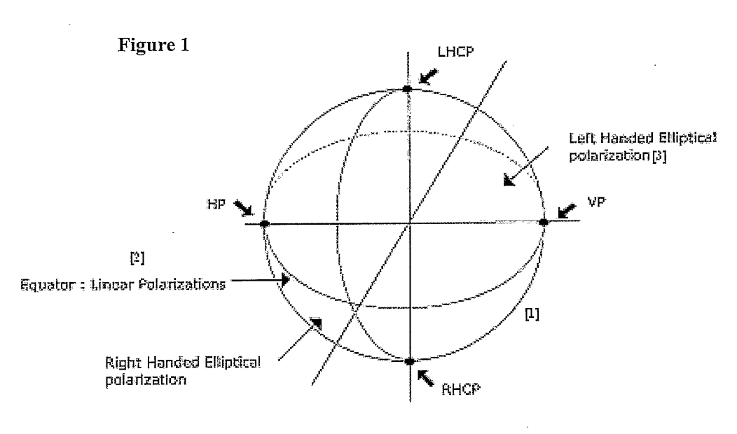

FIG. 1 shows a Poincaré sphere [1] which can be used to represent the SOPs on graphical representation. The linear polarizations are on the equator [2], the left handed polarizations [3] on the upper hemisphere, and right handed polarizations [4] on the lower hemisphere. The North Pole represents the LHCP [5] and South Pole represents the RHCP [6].

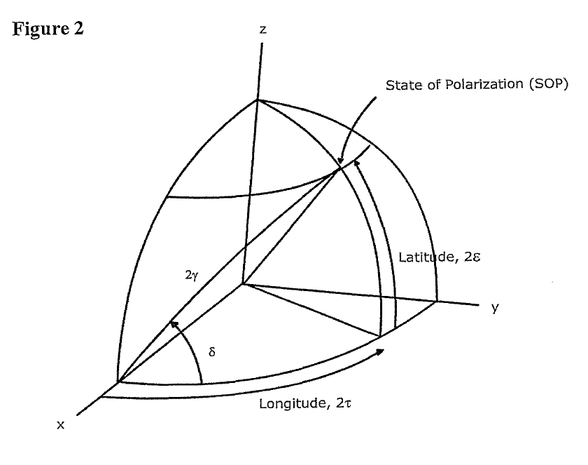

The points on the sphere are located using two pairs of angle which are related to each other, as shown in FIG. 2. The pair of angle used are:
1. (γ,δ) pair where 2γ is the great circle distance from the LHP [7] point and a is the angle of the great circle with respect to the equator.
2. (2τ,2ε) pair where 2τ is the longitude and 2ε is the latitude.

Any SOP can be represented mathematically as the combination of two orthogonal linear polarizations \vec{E}ₓ and \vec{E}ₓ.

\vec{E}ₓ=a₁ cos(τ+δ₁) (1)

\vec{E}_{y}=a₂ cos(τ+δ₂) (2)

where a₁ and a₂ are their respective amplitudes and

δ=δ₂−δ₁ (3)

is the phase difference between the y component of the electric field with respect to the x component. The angle γ is given by

$$γ = {tan}^{- 1} ( \frac{{a}_{2}}{{a}_{1}} ) \qquad ( 4 )$$

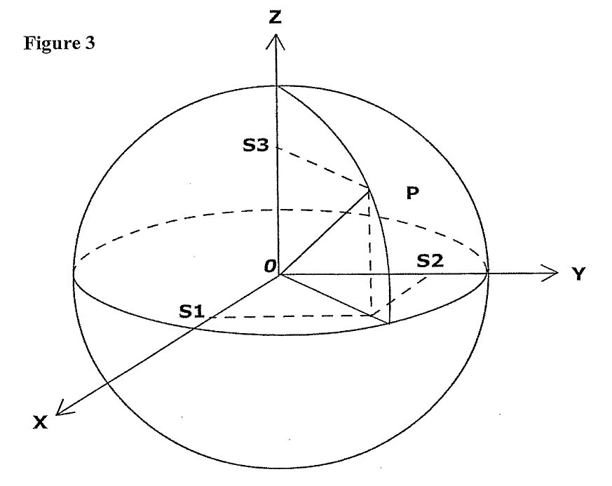

FIG. 3 shows another useful representation of SOP known in literature as Stokes parameters representation. Following the description in classical optics, for a signal with the {Ex, Ey, Ez} defined by

$$\begin{matrix}{E}_{x} = {a}_{1} cos ( τ + {δ}_{1} ) , \\ {E}_{y} = {a}_{2} cos ( τ + {δ}_{2} ) , \\ {E}_{z} = 0\end{matrix} \} \qquad ( 5 )$$

the Stokes parameters are given by

$$\begin{matrix}{s}_{0} = {a}_{1}^{2} + {a}_{2}^{2} , \\ {s}_{1} = {a}_{1}^{2} - {a}_{2}^{2} , \\ {s}_{2} = 2 {a}_{1} {a}_{2} cos δ , \\ {s}_{3} = 2 {a}_{1} {a}_{2} sin δ\end{matrix} \} \qquad ( 6 )$$

A general understanding of the polarization of an electromagnetic signal, various representations of polarization of a signal or antenna including Poincaré sphere and the Stokes space representation are provided below as a background for this disclosure.

Polarization shift keying is a modulation which is employed generally in optical communication systems. In this modulation, a constellation of 2, 4, 8 or M-ary points are designed in polarization domain. Each point on the constellation set (usually represented on the Poincaré sphere) represents a SOP of the transmitted signal. The data is then mapped on to these points and at the receiver the state of polarization of the received signal is sensed appropriately. The demodulation is performed in the Stokes space and the optimum receiver based on decision regions demodulates the received signal to regenerate the transmitted data. It has been shown that this modulation offers a better bandwidth and power efficiency compared to other M-ary modulation such as ASK, PSK or APK.

In PPOLSK, the assignment of data to the constellation point is made pseudo randomly. This is unlike the conventional POLSK where the data to constellation point mapping is time invariant.

A PN code is used at the transmitter to perform this random assignment of data to constellation point. In order to introduce multiple levels of randomness, multiple constellations are employed in this mapping procedure. A typical embodiment may use a 2 point, 4 point, 8 point and 16 point constellation sets. For each new symbol to be transmitted, firstly the constellation set to be used is determined randomly. Now to make the symbol assignment within this constellation random, each constellation arrangement has few separate arrangements. This means, a 2 point constellation may have 2 separate arrangements where in the same constellation point represent different data. Alternatively, the data can be scrambled before hand the mapping to achieve the same result.

In order to avoid additional complexity of synchronization, same PN sequence is decimated or sampled at suitable intervals to form two sequences, say randseq1 and randseq2, which are used at these two independent stages. The random ness properties of the resulting sequences are well studied in literature. These sequences are further sliced into successive p-tuple and q-tuple length words respectively, facilitating a set of K=2^{p} constellation sets and L=2^{q} separate arrangements for each constellation.

An example of multi-level randomness in selecting the constellation points is provided here. This example employs two levels of randomness for a PSK system using K=4 (p=2) modulation schemes with M=2,4,8,16 and each M-ary system having a maximum L=4 (q=2) different constellation arrangement A0, A1, A2, and A3. The general representation of the set of M-ary carrier phase modulated signal waveforms after incorporating randomness in constellation arrangements is given by

$${u}_{m} ( t ) = {g}_{T} ( t ) cos ( 2 π {f}_{c} t + \frac{2 π m}{{M}_{rand}} + {θ}_{rand} ) \\ For m = 0.1 . Mrand - 1 \\ {θ}_{rand} = {n}_{rand} \times ( 2 \frac{π}{{M}_{rand}} ) and {M}_{rand} , {n}_{rand} defined by \\ {M}_{rand} = {2}^{( 1 + {( randseq 1 )}_{4} )} \\ {n}_{rand} = {( randseq 2 )}_{4} \\ where \\ ( randseqx ) = ( msb , lsb ) \\ {and \\ ( randseqx )}_{4} = 2 ( msb ) + 1 ( lsb ) \qquad ( 7 )$$

For a particular M-ary scheme, there are 4 different constellation sets, which differ by the value of θ_{rand}. The subsequences randseq1 and randseq2 generated from the master sequence it may be noted that the subsequences are sliced into dibits so that each dibit can select one of the four possibilities of modulations and constellation arrangements. In a general implementation this may vary according to the specific requirements of the system. The 2-tuple randseq 1 and 2 can be generated by sampling the PN sequence for 2 bits or by decimating the sequence by a rate ½.

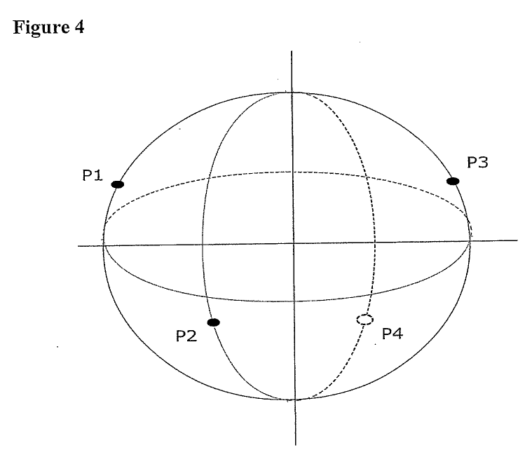

Optimum receiver in Stokes Space: When SOP of an EM signal is used for modulation in a wireless communication scenario within an AWGN channel, an optimum receiver can be designed in Stokes space. This optimum receiver has been derived for both 4 point and 8 point constellation arrangements. The 4 point constellation arrangement employed in a preferred embodiment is shown in FIG. 4.

Consider the symmetrically arranged 4 points on the Poincaré sphere shown in FIG. 4. Points on the upper plane are called High Plane 1 (HP1) and High Plane 2 (HP2). Points on the lower hemisphere are called Low Plane 1 (LP1) and Low plane 2 (LP2) respectively. Their coordinates in spherical coordinate system and their Poincaré representation parameters are given below:

TABLE 1
Essential data for the 4 point constellation

| Points | 2ε | 2τ | 2γ | δ | S₁ | S₂ | S₃ | α₁ | α₂ | δ |
|---|---|---|---|---|---|---|---|---|---|---|
| P₁ | 35.26 | 0 | 35.26 | 90 | 0.8166 | 0 | 0.5773 | 0.9530 | 0.3028 | 90 |
| P₂ | −35.26 | 90 | 90 | −35.26 | 0 | 0.8166 | −0.5773 | 0.7071 | 0.7071 | −35.26 |
| P₃ | 35.26 | 180 | 144.7 | 90 | −0.8166 | 0 | 0.5773 | 0.3028 | 0.9530 | 90 |
| P₄ | −35.26 | 270 | 90 | −144.7 | 0 | −0.8166 | 0.5773 | 0.7071 | 0.7071 | −144.7 |

It should be noted that these four points are at maximum Euclidean distance (dₘᵢₙ) between each other and is given by dₘᵢₙ=2\sqrt{2}/\sqrt{3}. It should be noted that these four points are at maximum Euclidean distance (dₘᵢₙ) between each other and is given by dₘᵢₙ=2\sqrt{2}/\sqrt{3}.

The electrical vectors of these 4 points are completely described by their amplitudes and relative phase differences that can be easily found from the Stokes parameters. The constituent electric vectors are given by the following equations for these four points at the z=0 plane.

### HP1:

\vec{E}ₓ(t)=0.953 (\vec{x} cos ωt)

\vec{E}_{y}(t)=0.303 {\vec{x} cos(ωt+90°)}

### HP2:

\vec{E}ₓ(t)=0.303(\vec{x} cos ωt)

\vec{E}_{y}(t)=0.953{\vec{x} cos(ωt+90°)}

### LP1:

\vec{E}ₓ(t)=0.707 (\vec{x} cos ωt)

\vec{E}_{y}(t)=0.707 {\vec{x} cos(ωt−35.27°)}

and LP2 given by

\vec{E}ₓ(t)=0.707 (\vec{x} cos ωt)

\vec{E}_{y}(t)=0.707 {\vec{x} cos(ωt+35.27°)} (8)

The optimum receiver in Stokes space can be derived from utilizing the spherical symmetry of the constellation arrangement For the points on the unit sphere, with \sqrt{Eₛ}=1 and

$${d}_{min} = \frac{2 \sqrt{2}}{\sqrt{3}} ,$$

the set of coordinates of each point is given as below.

$$H P 1 \text{:} \{ {d}_{min} / 2 , 0 , {d}_{min} / 2 \sqrt{2} \} \\ H P 2 \text{:} \{ - {d}_{min} / 2 , 0 , {d}_{min} / 2 \sqrt{2} \} \\ L P 1 \text{:} \{ 0 , {d}_{min} / 2 , - {d}_{min} / 2 \sqrt{2} \} and \\ L P 2 \text{:} \{ 0 , - {d}_{min} / 2 , - {d}_{min} / 2 \sqrt{2} \} \qquad ( 9 )$$

Let n₁, n₂, n₃ be the relevant noise components along the three axes with zero mean and variance σ²=η/2. It will be convenient to calculate the probability of correct decision p_{c} and then determine the probability of symbol error as pₛ=1−p_{c}.

Assuming that the point HP2 is transmitted, the probability of a correct decision is given by

$$\begin{matrix}P ( C / {HP}_{2} ) = ( \frac{1}{\sqrt{( πη )}} {\int }_{- ∞}^{d / 2} {e}^{- {n}_{1}^{2} / η} d {n}_{1} ) ( \frac{1}{\sqrt{( πη )}} {\int }_{- d / 2}^{d / 2} {e}^{- {n}_{2}^{2} / η} d {n}_{2} ) \\ ( \frac{1}{\sqrt{( πη )}} {\int }_{- d / 2 \sqrt{2}}^{∞} {e}^{- {n}_{3}^{2} / η} d {n}_{3} ) \\ = ( 1 - Q ( \frac{d}{\sqrt{( 2 η )}} ) ) ( 1 - 2 Q ( \frac{d}{\sqrt{( 2 η )}} ) ) ( 1 - Q ( \frac{d}{2 \sqrt{η}} ) )\end{matrix} \qquad ( 10 )$$

Assuming an equi-probable transmission of symbols, the symbol error probability of the system is given by

pₑ(s)=1−p(c/HP₂) (11)

Equation (8) can be expressed in terms of the bit energy E_{b} as shown below. The Euclidean distance is related to the symbol energy (radius of the sphere) as

$$d = \frac{2 \sqrt{2}}{\sqrt{3}} \sqrt{{E}_{s}} \\ {d}^{2} = \frac{16}{3} {E}_{b} \qquad ( 12 )$$

Substituting this into equation (8), and replacing η=Nₒ

$${p}_{e} ( s ) = 1 - [ ( 1 - Q ( \frac{2 \sqrt{2}}{\sqrt{3}} \sqrt{\frac{{E}_{b}}{{N}_{o}}} ) ) ( 1 - 2 Q ( \frac{2 \sqrt{2}}{\sqrt{3}} \sqrt{\frac{{E}_{b}}{{N}_{o}}} ) ) ( 1 - Q ( \frac{2}{\sqrt{3}} \sqrt{\frac{{E}_{b}}{{N}_{o}}} ) ) ] \qquad ( 13 )$$

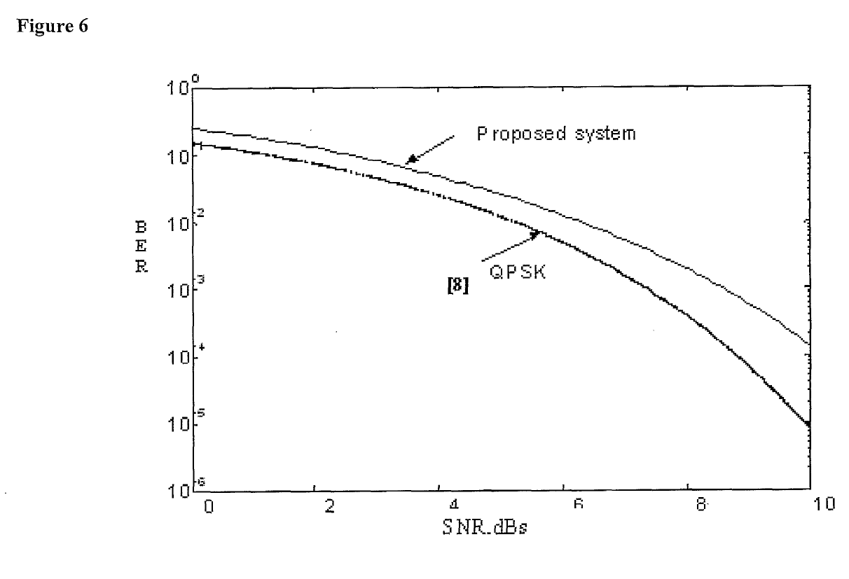

The above equation gives the BER performance in a closed form and it is compared to that of QPSK [8] in the FIG. 6.

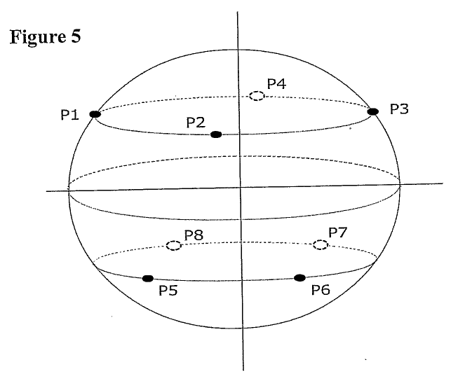

Another constellation which is used in a preferred embodiment is an 8 point constellation shown in FIG. 5. Its performance in an AWGN channel is given by

$${p}_{e} ( s ) = 1 - [ ( 1 - Q ( \sqrt{2} \sqrt{\frac{{E}_{b}}{{N}_{o}}} ) ) ( 1 - 2 Q ( \sqrt{2} \sqrt{\frac{{E}_{b}}{{N}_{o}}} ) ) ( 1 - Q ( \sqrt{2} \sqrt{\frac{{E}_{b}}{{N}_{o}}} ) ) ]$$

(14)

Their coordinates in spherical coordinate system and their Poincaré representation parameters for an 8 point constellation are given below:

TABLE 2
Essential data for the 8 point constellation

| Points | 2ε | 2τ | 2γ | δ | S₁ | S₂ | S₃ | α₁ | α₂ | δ |
|---|---|---|---|---|---|---|---|---|---|---|
| P₁ | 35.26 | 0 | 35.26 | 90 | 0.8166 | 0 | 0.5773 | 0.9530 | 0.3028 | 90 |
| P₂ | 35.26 | 90 | 90 | 35.26 | 0 | 0.8166 | 0.5773 | 0.7071 | 0.7071 | 35.26 |
| P₃ | 35.26 | 180 | 144.7 | 90 | −0.8166 | 0 | 0.5773 | 0.3028 | 0.9530 | 90 |
| P4 | 35.26 | 270 | 90 | 144.7 | 0 | −0.8166 | 0.5773 | 0.7071 | 0.7071 | 144.7 |
| P5 | −35.26 | 45 | 54.73 | −45 | 0.5773 | 0.5773 | −0.5773 | 0.8881 | 0.4597 | −45 |
| P6 | −35.26 | 135 | 125.27 | −45 | −0.5773 | 0.5773 | −0.5773 | 0.4597 | 0.8881 | −45 |
| P7 | −35.26 | 225 | 125.27 | −135 | −0.5773 | −0.5773 | −0.5773 | 0.4597 | 0.8881 | −135 |
| P8 | −35.26 | 315 | 54.73 | −135 | 0.5773 | −0.5773 | −0.5773 | 0.8881 | 0.4597 | −135 |

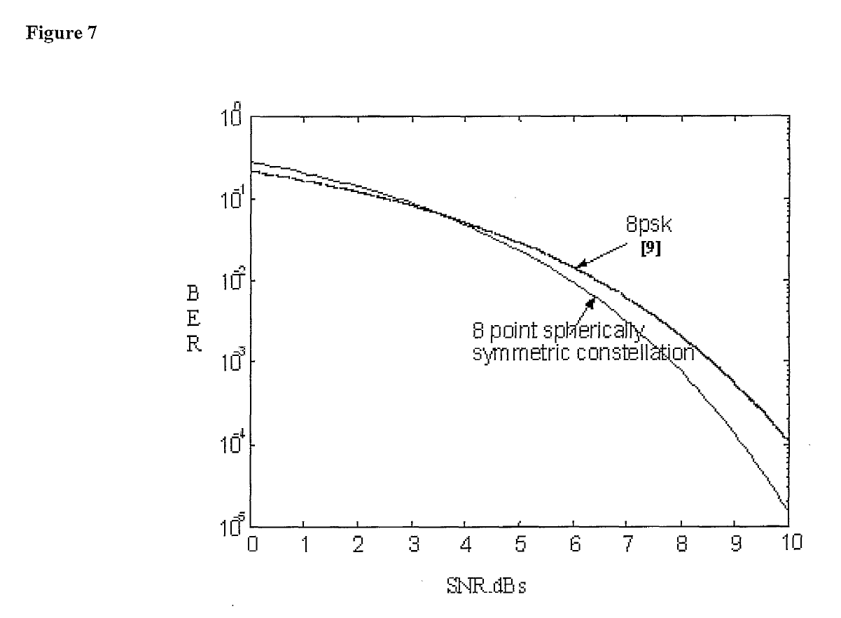

This is plotted in the FIG. 7 for comparison with an 8PSK [9] system. It has been proven here that as the value of M goes higher, an M-ary POLSK system offers higher power efficiency than a similar ordered M-ary PSK system. It has also been shown that a POLSK signal is a narrow band signal. The bandwidth efficiency of M-ary POLSK system gets better with higher values of M.

In PPOLSK, the final error rate is determined by the individual constellation arrangements employed. The over all error rate is a weighted average of the error rates of the constellation sets employed. The bandwidth occupation of the PPOLSK signal is determined by the constellation with minimum number of constellation points as this contributes the higher frequency components compared to other constellation arrangements

When PPOLSK is implemented in its preferred embodiment, a signal processor is preferred at the transmitter to perform the base band processing. The base band processor generates a Master PN sequence and does the pseudo random assignment of data to the constellation points. These constellation points are polarization of an electromagnetic signal. It is generated by using a dual polarized array with high isolation. The dual polarized array has two separate antenna elements, one for LHP [7] and another one for linear vertical polarization (LVP) [10]. Alternatively, these elements can be LHCP [5] and RHCP [6]. These elements are then fed with appropriate sinusoidal signals to generate the required SOP.

The amplitudes a₁, a₂ and the relative phase shift a of the feed signals for each SOP is stored in a Look Up Table (LUT). The sinusoidal signal of the required amplitude and phase is generated by using the values stored in the LUT and by using a direct digital synthesizer (DDS). The DDS output is then fed to a digital up converter (DUC) and the output of the DUC is converted into analog signal for further analog up conversion to the required frequency of operation of the system. Alternatively, the output of the DDS can be converted to analog for analog up conversion to IF and then to the RF. When these signals of appropriate amplitude and relative phases are fed to the dual polarized array, the required SOP will be generated in the far field of the antenna.

At the receiver, there are two alternate implementation schemes. One implementation is a practical realization of the Stokes space receiver and the other implementation is based on Multiple Input Multiple Output (MIMO) processing. Detailed description of these receiver schemes is given in the sections to follow. These receiver architectures perform the demodulation operation and then the data is applied to the inverse mapping algorithm. The inverse mapping algorithm needs a locally generated PN sequence which is in synchronization with the PN code at the transmitter.

A practical implementation of such a system will also need an efficient channel coding technique, an inter-leaver and optionally a space time code to further provide a coding and diversity gain.

The anti jam features of the system can be enhanced by employing suitable algorithms as can be seen in the sections to follow. In order to achieve the complex requirements of employing multiple algorithms at the receiver, the preferred embodiment will involve a signal processor or a circuit with processing capability such as a field programmable gate array (FPGA). A preferred implementation involving processors at transmitter and receiver is one which is based on Software Defined Radios (SDR). In such an implementation, by employing innovative channel estimation, jamming signal estimation, adaptive polarization nulling algorithm and other appropriate receiving algorithms such as Maximum likely cross polarization interference canceller (ML XPIC) algorithm, an efficient and high speed PPOLSK transmission and reception can be achieved. With PPOLSK as the modulation, the wireless link possessed the desired qualities of low probability of exploitation and anti jamming.

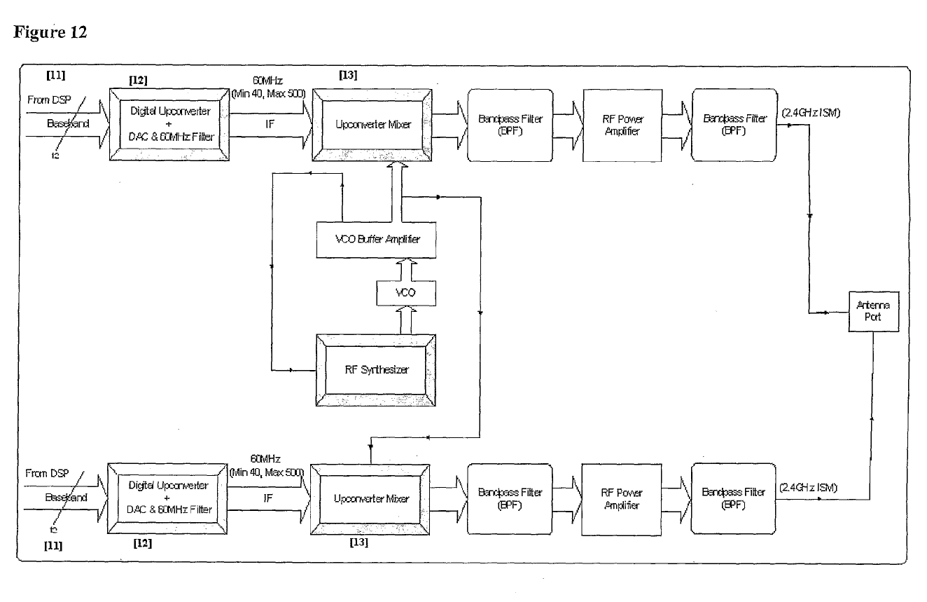

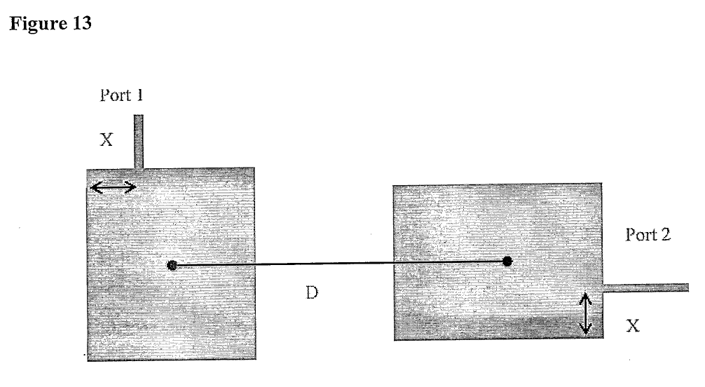

The transmitter of a PPOLSK based communication system is based on a programmable device to incorporate the adaptive features of the transmitter. There are two separate schemes that are presented here. In the first form of embodiment, a Digital Signal Processor (DSP) [11] is employed to perform the operations at the base band and the output of this stage is given to digital up-converter [12] followed by an analog up-converter [13]. The block schematic is given in FIG. 12. DSP performs firstly the constellation selection, and mapping of the data pseudo randomly to the constellation point. Based on the SOP selected for transmission, the two sinusoidal signals of appropriate amplitudes and relative phases are generated to be up-converted and fed to the two ports of the antenna array. One preferred embodiment of the antenna is shown in FIG. 13.

To illustrate this further, an example is provided here. At some point of operation, let the constellation point selected be P1 of FIG. 4. This SOP can be represented by

\vec{E}ₓ(t)=0.953 (\vec{x} cos ωt)

\vec{E}_{y}(t)=0.303 {\vec{x} cos(ωt+90°)}

In order to generate this SOP, two sinusoids representing the above equations is required and this is performed by the DSP [11] with the help of a DDS function. The signal Ex (t) needs to be fed to the port 2 LHP [7] and the signal Ey (t) to the port 1 LVP [10]. For this a digital upconverter [12] followed by an analog upconverter [13] is used as shown in FIG. 12.

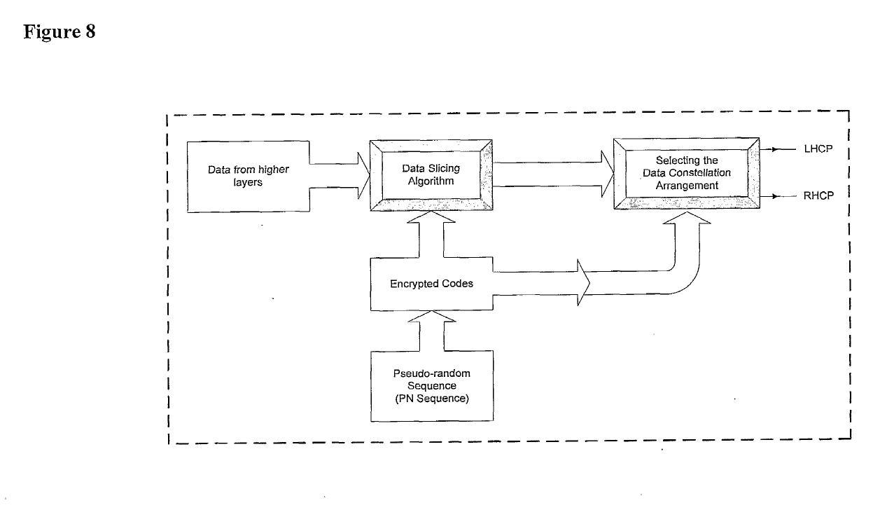

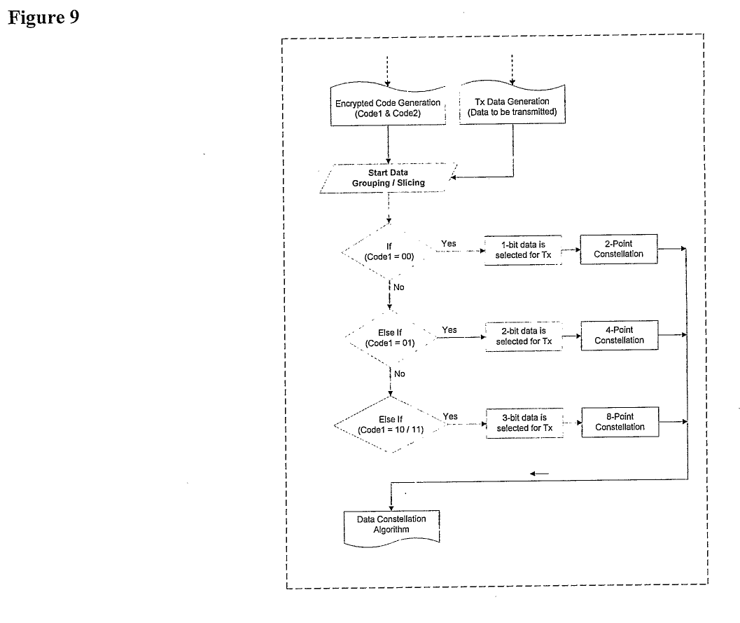

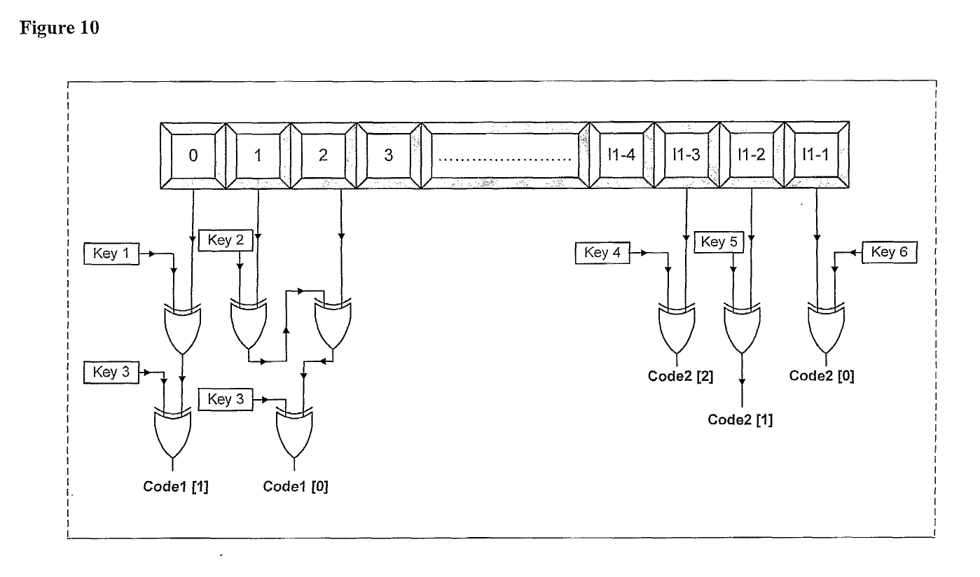

The pseudo random symbol selection operation of PPOLSK is shown in FIGS. 8, 9, 10, and 11. FIG. 8 gives an overview of the entire symbol mapping operation. In a preferred embodiment, 4 different constellation arrangements are used, and they are 2 point constellation, 4 point constellation, 8 point constellation and 16 point constellation. In such a case, the PN code together with an external code value from a subscriber identification module generates two separate code sequences code 1 and code 2. The code 1 is used to select the constellation (within the 4 possible sets, 2, 4, 8, 16 points) pseudo randomly. The code 2 is used for the pseudo random data mapping into the selected constellation point. Once the selection of the constellation is performed by code 1, the data need to be sliced accordingly. If the constellation selected is 4 point, the data needed is a 2 bit sequence (dibit) and if the constellation selected is a 16 point constellation, the data needed is a 4 bit sequence. This is performed by the data slicing algorithm. The sliced data is then fed to the mapping section where this data is assigned to a SOP based on the code 2. Operation at the data slicing section is further illustrated in the FIG. 9. FIG. 10 illustrates how the code 1 and code 2 are generated from a master sequence and a seed value input from a subscriber identification module. This stage can be customized to suit the specific requirements of the authentication of the systems.

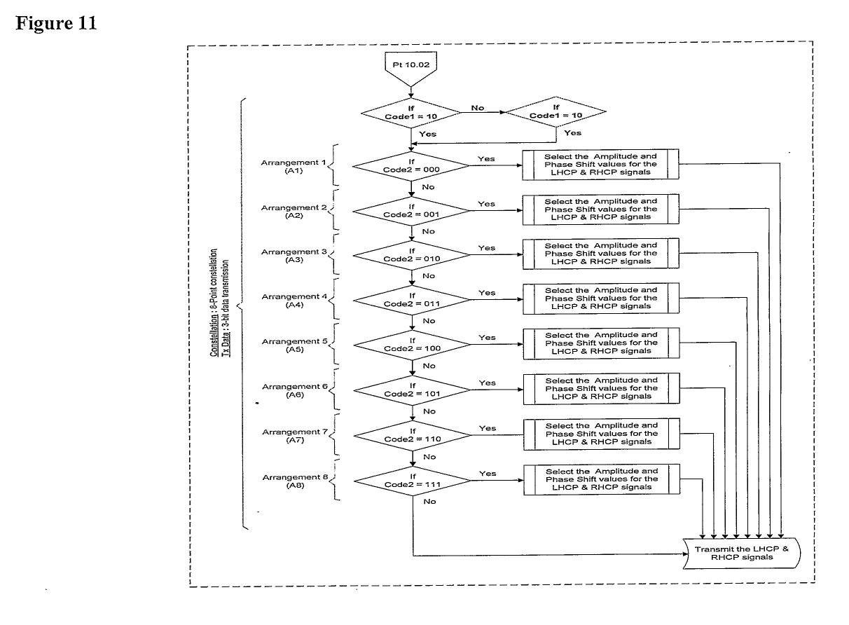

FIG. 11 illustrates the mapping of the data to the specific constellation point. For instance, after the code 1 has selected an 8 point constellation, code 2 is used to map the particular constellation point to the data. The Figure shows that there are 8 alternate arrangements within this constellation set. In other words, the 8 point constellation has 8 different types of symbol arrangements which are decided by the code 2 value. Such a scheme can also be implemented by scrambling the sliced data with code 2. The selection of constellation set pseudo-randomly by code 1 and further selection of one of the specific symbol arrangements within this set by code 2 imparts multiple levels of randomness to the PPOLSK scheme, thus enhancing the LPE features of the signal.

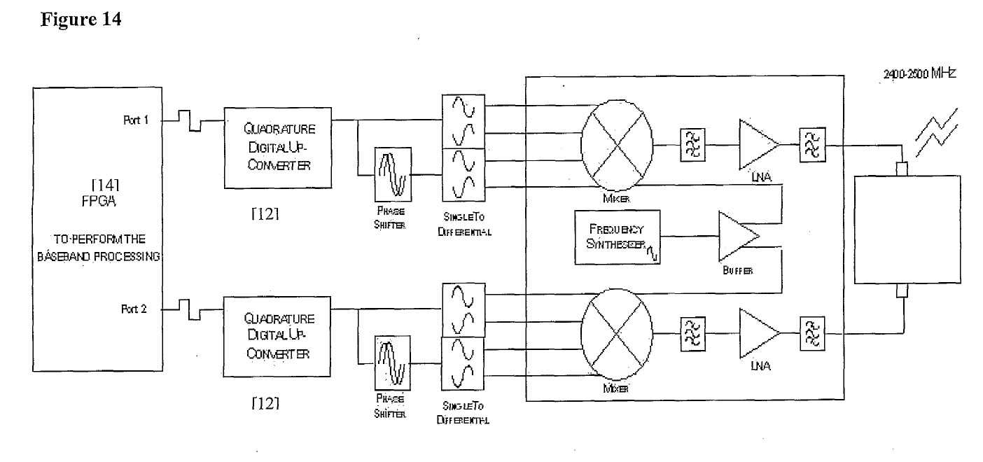

FIG. 14 shows another implementation of a PPOLSK scheme where the base band processing is performed by a field programmable gate array (FPGA) [14]. The signal generated by the FPGA [14] is digitally up-converted by a digital up-converter [12] and then analog up-converted [13] by a single sideband mixing process to the antenna frequencies.

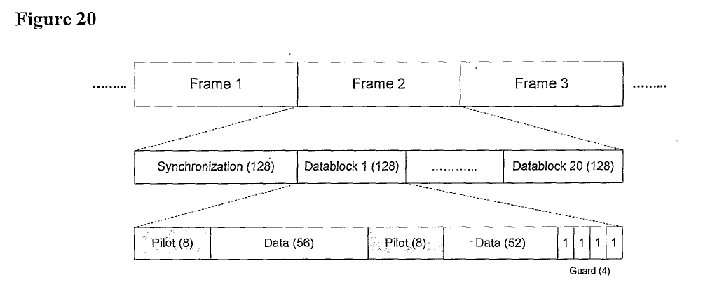

In order to perform the synchronization and training of the system, the data is packetized as shown in FIG. 20. A frame consists of 128 bit (non random, pre defined) timing Synchronization sequence, followed by 20 data blocks each 128 bit in size. Each data block has a 10 symbol pilot sequence (known apriori at the receiver) for the training of the receiver channel estimator. During this phase, the channel estimation and jamming estimation is performed at the receiver.

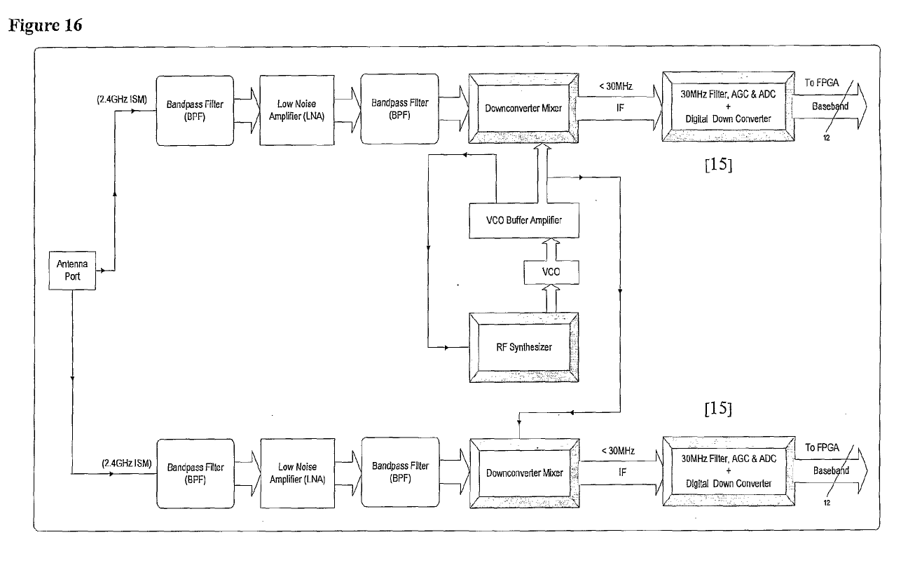

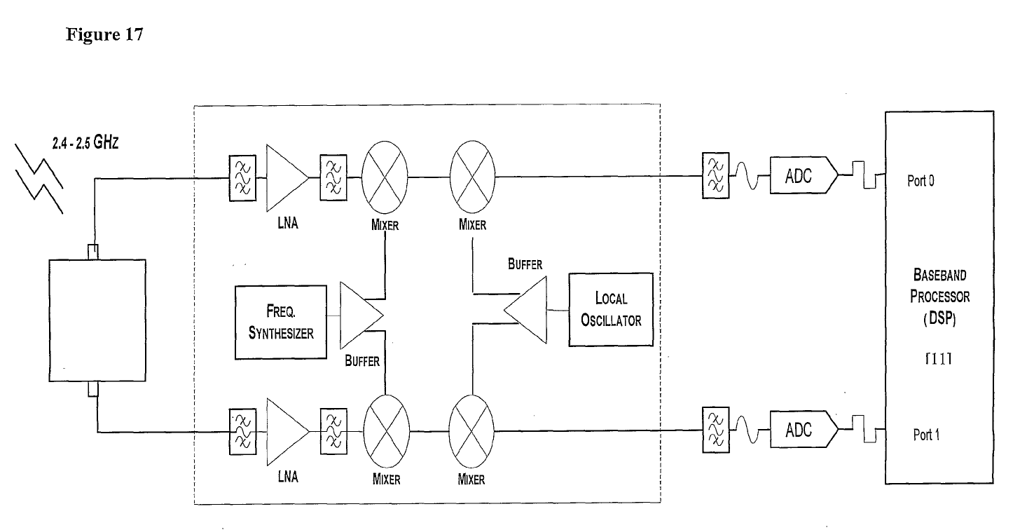

Receiver circuit of the proposed invention needs programmability to implement the various algorithms effectively. This can be provided by a Digital Signal Processor [11] or an FPGA [14]. The received signal at radio frequency needs to be down converted using a digital down converter [15] to base band before processing by the base band processor. Block schematic of a circuit to perform this down conversion and the base band processing are shown in FIGS. 16 and 17. The FIG. 16 shows an analog down conversion to IF and a digital down conversion [15] to base band and then processing by an FPGA [14]; FIG. 17 shows a similar down conversion and subsequent base band processing by a DSP [11] processor.

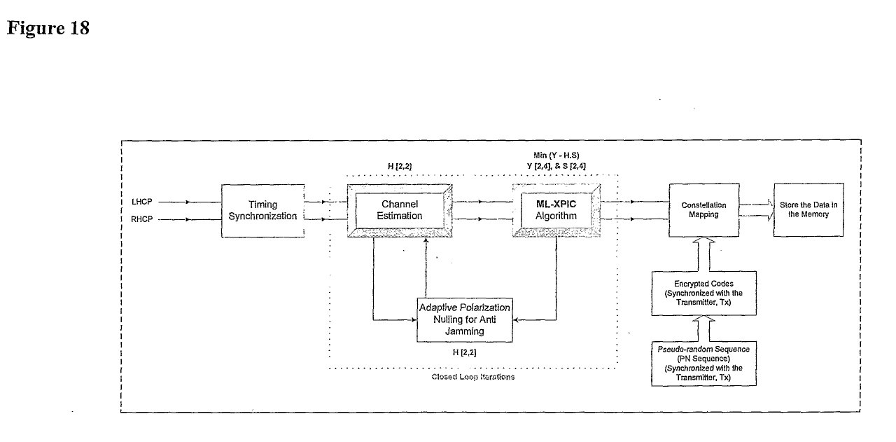

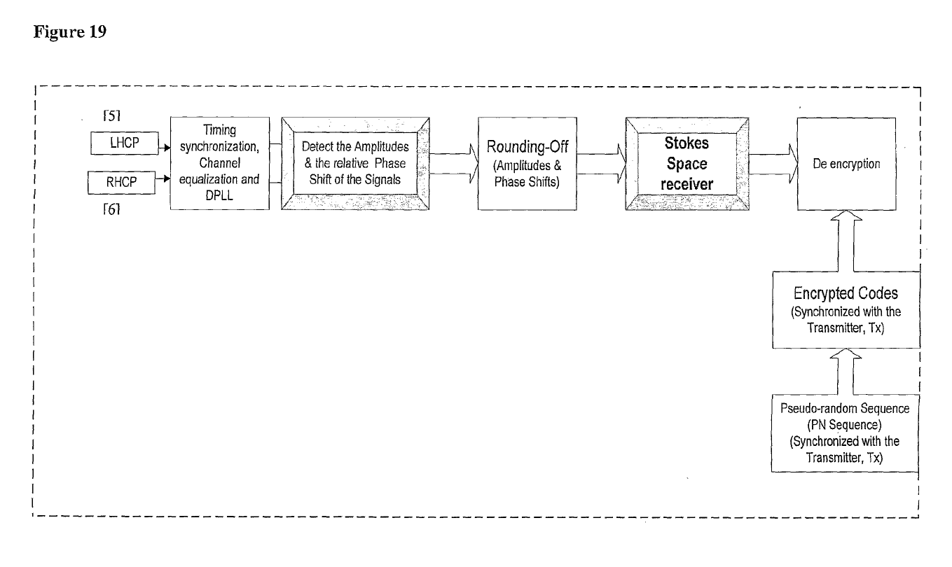

A PPOLSK detection circuit can be implemented in two ways. One method is a receiver in Stokes space and the other method is a MIMO processing based receiver design. The block diagram of the receiver signal processing based on MIMO processing is shown in FIG. 18. FIG. 19 shows the block diagram of the receiver based in Stokes space. The first operation performed is a timing synchronization. This is followed by a channel estimation block and then the ML XPIC block. Completing the closed loop is the APN block which takes the input from both channel estimates and the ML XPIC algorithm.

The timing synchronization algorithm can be based on any of the efficient prior art methods such as correlation. In a preferred embodiment, a training sequence of 128 symbols is transmitted at the start of every data-block burst, and is transmitted from only one channel or both channels. The synchronization is then performed on the known training sequence of length 128 symbols or 512 samples (4 samples/cycle). The received training sequence is then cross-correlated with the locally stored, known, training sequence of length 512 samples. It is important that this training sequence has good auto-correlation properties; a peak at the optimal sampling instant. This means that the training sequence should be white, and this gives a good peak at the correct sampling instant.

E[t(n).t(n+k)]=δ(k)

The cross-correlation is calculated as,

$$r ( t ) = {\sum }_{k = 0}^{511 - t} y ( k + t ) \cdot s ( t )$$

where, ‘y’ is the received signal, and ‘s’ is the desired signal

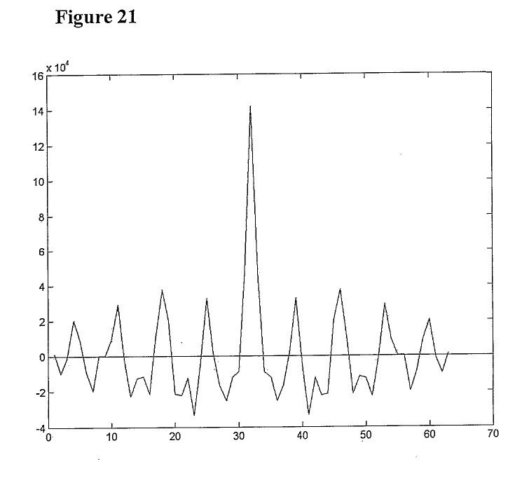

The optimal sampling instant is when ‘r(t)’ has a peak value as shown in the FIG. 21.

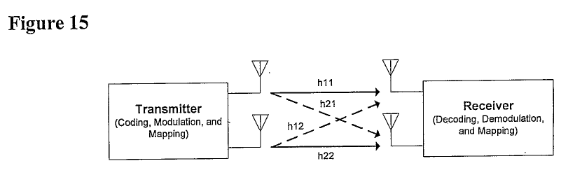

The channel model of a preferred embodiment is shown in FIG. 15. This channel is estimated during the pilot phase of the transmission. Any of the prior art methods such as least squares, semi blind or blind methods can be used for this purpose.

The channel estimate H can be represented as,

$${H}_{ts} = [ \begin{matrix}{h}_{11} & {h}_{12} \\ {h}_{21} & {h}_{22}\end{matrix} ]$$

The ML XPIC algorithm is similar to the maximum likely hood algorithm used in MIMO signal processing for signal detection. The constellation point closest (in Euclidean Distance) to the received symbol is the detected point. This is decided by an algorithm, which involves the computation of the minimum error matrix expressed as;

e=min|y−h.s|

where,
‘y’ is the received/detected signal or symbol
‘s’ is all the possible constellation points or symbols
and ‘h’ is the channel matrix for all the possible constellation points or symbols

The important difference between a conventional ML algorithm and a ML XPIC algorithm is that, the channel coefficients are considered as co polar and cross polar polarization coefficients. In other words, the channel matrix is considered as the polarization matrix. Another difference is that the error computation involves a weighting factor which is based on the feedback from the APN algorithm. If APN detects the presence of a jammer, and if one of the received antennas is heavily affected by jamming, the contribution of the error from this antenna is weighted down to reduce its effect in the decision making. This feature is made adaptive depending on the jammer signal strength.

The adaptive polarization nulling algorithm uses the pilot phase of transmission to determine the presence of a jammer. In order to facilitate this operation, the pilot phase of transmission is based on a 4 point constellation, the points being LHP [7] (P1), LVP [10] (P2), LHCP [5] (P3) and RHCP [6] (P4). When P1 is transmitted, the vertically polarized antenna is fed with no signal. At the receiver, if the LVP [10] antenna is receiving a signal whose power rises above a threshold, the presence of a jammer is identified and the signal information is saved for further processing. Similarly, when P2 is transmitted, the LHP [7] antenna is not transmitting any signal. At the receiver, if the LHP [7] antenna is receiving a signal whose power goes above a threshold, the presence of the jammer is identified and the sample values are saved. From the amplitudes and relative phase of the saved sample values, the polarization and strength of the jammer signal is computed. Such a computation is straight forward and a weighting factor is determined adaptively and passed to the ML XPIC algorithm. Apart from this, optionally, the algorithm sends a feedback signal during the guard phase of transmission to the transmitter. This feedback is a bit stream which communicates the presence of the jammer and its SOP so that the transmitter can adaptively change the transmitted power from the antenna to counter act the jamming. For instance, if the LHP [5] antenna at the receiver is heavily affected by jamming, the transmitter will increase the transmitted power from the LHP [5] antenna and correspondingly decrease the power from the vertical antenna.

The received bit stream from the ML XPIC algorithm is then passed on to the Inverse hopping algorithm at the receiver. The PN code at the receiver which is in synchronization with the PN code at the transmitter is used to recover the original data which is then buffered and transferred to the higher layers of the system or network.

In the second approach of signal detection, as shown in FIG. 19, the receiver signal processing is performed in the Stokes space. The received signal amplitudes and their relative phase are determined from their sample values. These amplitude and phase values are then used to determine the received signal polarization. Then the optimum receiver makes the decision based on the minimum distance criteria about the transmitted signal. This operation is performed by the block “Stokes Space Receiver” of the block diagram in FIG. 19. The demodulated data is then given to the inverse hopping section to perform the inverse mapping. This is performed at the block “Decryption” of the Figure. It uses the same PN code as the transmitter and generates original data which is buffered and fed to the higher layers of the system or network.

While the invention has been described with respect to a limited number of embodiments, it will be appreciated that many variations, modifications and other applications of the invention may be made.

I claim:

1. A secure wireless communication system and method offering low probability of exploitation and anti jamming features to the communication link, the system comprising:
a pseudo random polarization shift keying modulation method which employs the State of Polarization of an electromagnetic wave as the modulation parameter;
a polarization agile antenna system which comprises of a signal processor and a microstrip array to generate, transmit and receive the desired polarizations;
a transmitter which comprises of a signal processor and/or Field Programmable Gate Array for mapping data onto a specific State of Polarization, the transmitter generates the required signals of appropriate amplitude and phase for feeding the polarization agile antenna structure and receives feedback from the receiver to adaptively decide the constellation points and their transmission power aimed at offering higher jamming margin; and
a receiving system which employs a cross polarization interference canceller, a Least squares based algorithm for channel estimation, an adaptive polarization nulling algorithm for anti jamming and other necessary algorithms for efficient reception of the digital information.

2. A system of claim 1 wherein the secure and anti jamming wireless communication system does not require spectral redundancy.

3. A transmitter of claim 1 which performs a scanning of the channel for determining the jammer polarization before performing the data transmission and subsequently transmits the training/synchronization part of the data in the orthogonal polarization.

4. The polarization agile antenna system of claim 1 wherein the antenna array consists of two separate antennas which are orthogonal in polarization such as linear horizontal polarization & linear vertical polarizations or left handed circular polarization & right handed circular polarizations.

5. The method of claim 1 whereby the cryptic nature of the signals are enhanced by using multiple level of randomness in that a pseudo random code is used to select the State of Polarizations from a multitude of constellation sets in the polarization domain and to map the digital information on to electromagnetic signal of varying polarizations.

6. A method of claim 5 wherein the pseudo-random noise sequence code is decimated to two subsequences, one of which is used to select the constellation arrangement and the other to randomize the data or specific symbol assignment within a constellation arrangement.

7. The system of claim 1 wherein the receiver consists of a dual polarization array antenna to receive the transmitted signal, a cross polarization interference cancellation algorithm, a maximum likely algorithm to receive the signal efficiently, and an adaptive polarization nulling algorithm for anti jamming.

8. The system of claim 7 wherein the adaptive polarization nulling algorithm of the receiver provides feedback to the transmitter about the presence and polarization of the jammer and the transmitter adaptively increases the power of the signal transmitted through the antenna which is more affected by jamming and correspondingly reduces the power of the signal transmitted through the antenna which is less affected by jamming signal.

9. The system of claim 8 wherein the transmitter on receiving the feedback from the receiver about the presence of the jammer adaptively changes the constellation set to another set which employ polarizations which are less affected by the jamming power.

10. The system of claim 1 wherein the wireless communication on a point to point basis or a point to multipoint basis at the physical layer provides an anti-jamming communication system with low probability of exploitation which can be used for secure broadband wireless access.

11. The system of claim 1 wherein the wireless communication on a point to point basis or a point to multipoint basis at the physical layer provides an anti-jamming communication system with low probability of exploitation which can be used for local area networks.

12. The system of claim 1 wherein the wireless communication on a point to point basis or a point to multipoint basis at the physical layer provides an anti-jamming communication system with low probability of exploitation which can be used for setting up a secure and survivable tactical communication wireless network.
